(19) United States
(12) Patent Application Publication
(10) Pub. No.: US 2010/0000389 A1
(43) Pub. Date: Jan. 7, 2010

(54) Cutter wheel with surface modification and method for manufacturing the same

(75) Inventors: Hsiao-Kuo Chang, Taoyuan City (TW); Ming-Hui Wang, Taipei City (TW)

Correspondence Address: BACON & THOMAS, PLLC, 625 SLATERS LANE, FOURTH FLOOR, ALEXANDRIA, VA, 22314-1176, US

(73) Assignee: Kinik Company, Taipei (TW)

(21) Appl. No.: 12/292,360

(22) Filed: Nov. 18, 2008

(30) Foreign Application Priority Data
Jul. 2, 2008 (TW) 097124829

(51) Int. Cl. C03B 33/10; B26D 1/14; B23K 1/20; B23K 31/10; B26B 9/00

(52) U.S. Cl. 83/676; 30/347; 228/164; 228/172; 228/170

(57) ABSTRACT

A cutter wheel is disclosed, which comprises a cutter wheel body, a cutting unit, and a solder layer. The cutter wheel body consists of the first substrate and the second substrate, wherein each substrate has an inner surface and an outer surface. The inner surface of the first substrate is treated with surface modification. The cutting unit can be formed on a rough surface. The solder layer is formed between the cutting unit and the second substrate. The present invention also provides a method for manufacturing the cutter wheel as mentioned above.

### BACKGROUND OF THE INVENTION

1. Field of the Invention

The present invention relates to a cutter wheel and a method for manufacturing the same, and, more particularly, to a cutter wheel having surface-modified substrates, which can enhance the attachment intensity between the substrates and a cutting unit, and an increased cutting efficiency and a method for manufacturing the same.

2. Description of Related Art

Generally, cutter wheels are made of materials having a sufficient hardness for cutting particularly hard materials, and thus are applied in various purposes such as glass cutting, chip cutting, circuit board cutting, medical cutting apparatus, CMP conditioners, household cutters for daily use, specific electrodes, metal composite cooling fins, grinding wheel dressers and so on.

U.S. Pat. No. 5,855,974 discloses a scribing wheel structure, which is pretreated with chemical solutions such as KOH and K₃Fe(CN)₆ respectively to remove cobalt on the surface of wolfram carbide and to roughen the surface of wolfram carbide. Then, a CVD diamond film is plated only on the scribing edge of the scribing wheel. U.S. patent publication No. 2007056171 discloses a cutter wheel structure where a CVD diamond layer is interposed between protrusion substrates. Besides, JP patent No. 60-201803 discloses a cutter wheel where both sides of the substrate are encompassed by sintered diamond particles.

As the above-mentioned, substrates and a CVD diamond layer or sintered diamond particles consist of a cutter wheel structure in the prior arts. However, when the CVD diamond layer or the sintered diamond particles are combined to the substrates, the attachment intensity between the diamond and substrate is insufficient. It will cause the CVD diamond layer or the sintered diamond particles to peel off the substrates. Thus, the cut glass is also broken easily. Hence, the service life and the cutting efficiency of the cutter wheels cannot be promoted effectively, and they are still waiting amelioration.

Accordingly, there is still a need for improved cutter wheels and manufacturing methods thereof having desirable service life and cutting efficiency, low costs and ease for operation.

### SUMMARY OF THE INVENTION

The object of the present invention is to provide a structure of a cutter wheel in which substrates are surface-modified to form a rough portion to prevent a cutting unit from peeling off the substrates.

Another object of the present invention is to provide a structure of a cutter wheel in which the deterioration probability of a cutting unit can be reduced by decreasing times of soldering at a high temperature so as to efficiently promote the attachment of the cutting unit to the substrates.

To achieve the objects, a cutter wheel of the present invention includes a cutter wheel body, a cutting unit, and a solder layer. The cutter wheel body consists of a first substrate and a second substrate. The first and second substrates each has an inner surface and an outer surface. A modified surface is formed on the inner surface of the first substrate. The cutting unit is formed on the rough portion. The solder layer is formed between the cutting unit and the second substrate.

According to the cutter wheel illustrated in a preferred embodiment of the present invention, the inner surface of the first substrate is surface-modified by plasma treatment or acid corrosion to form a rough portion. The rough portion is composed of multiple protrusions.

According to the cutter wheel illustrated in a preferred embodiment of the present invention, the outer diameter of the inner surfaces of the first and second substrates is larger than that of the outer surface thereof.

According to the cutter wheel illustrated in a preferred embodiment of the present invention, the cutter wheel body has a plurality of the first axle holes. Besides, the cutting unit has a second axle hole, and the first and second axle holes penetrate through the cutter wheel body and the cutting unit, respectively.

According to the cutter wheel illustrated in a preferred embodiment of the present invention, the material of at least one of the substrates comprises metal, metal carbide, metal alloy, metal nitride, or metal oxide. Preferably, the material such as carbon, nitrogen, oxygen, boron, aluminum, silicon, wolfram, the metal alloy thereof, or the compound thereof is used. The thickness of the substrates is 0.1˜10 mm.

According to the cutter wheel illustrated in a preferred embodiment of the present invention, the first and second axle holes respectively have a plurality of concavo-convex portions continuously disposed therein. The first and second axle holes are disposed in the centers or off the centers of the cutter wheel body and the cutting unit.

According to the cutter wheel illustrated in a preferred embodiment of the present invention, the cutting unit includes a chemical vapor deposition diamond layer, of which the thickness is 5 μm to 1 mm.

According to the cutter wheel illustrated in a preferred embodiment of the present invention, the cutting unit includes a cutter edge. The cutter edge is smooth arcs or irregular serrations.

According to the cutter wheel illustrated in a preferred embodiment of the present invention, the substrates further comprise a flange structure in the center thereof. The flange structure has an axle hole disposed in the center thereof, and is sleeved onto the surfaces of the first and second substrates.

According to the cutter wheel illustrated in a preferred embodiment of the present invention, the solder layer comprises silver/copper/tin/titanium powders, or nickel/chromium alloy powders.

In addition, the present invention further provides a method for manufacturing the aforementioned cutter wheel, comprising the following steps: providing a cutter wheel body, consisting of a first substrate and a second substrate, wherein the first and second substrates each has an inner surface and an outer surface; surface-modifying the inner surface of the first substrate to form a rough portion thereon; forming a cutting unit on the rough portion; forming a solder layer on the inner surface of the second substrate; and aligning and connecting the first and second substrates by the solder layer.

According to the method for manufacturing the cutter wheel illustrated in a preferred embodiment of the present invention, the inner surface of the first substrate is surface-modified by plasma treatment or acid corrosion. When the plasma treatment is performed to surface-modify the inner surface of the first substrate, it is carried out under the atmosphere of oxygen or hydrogen.

According to the method for manufacturing the cutter wheel illustrated in a preferred embodiment of the present invention, a cutter edge is formed on the periphery of the cutting unit, and the cutter edge is smooth arcs or irregular serrations. The method of forming the cutter edge comprises mechanical polishing or electrical discharge wire cutting.

According to the method for manufacturing the cutter wheel illustrated in a preferred embodiment of the present invention, a plurality of the first axle holes and a second axle hole are formed respectively in the cutter wheel body and the cutting unit. The first and second axle holes penetrate through the cutter wheel body and the cutting unit, respectively.

According to the method for manufacturing the cutter wheel illustrated in a preferred embodiment of the present invention, the first and second axle holes respectively have a plurality of concavo-convex portions continuously disposed therein. The first and second axle holes are disposed in the centers or off the centers of the cutter wheel body and the cutting unit. The method of forming the first and second axle holes comprises electrical discharge wire cutting or machining.

According to the method for manufacturing the cutter wheel illustrated in a preferred embodiment of the present invention, the method of forming the cutting unit comprises chemical vapor deposition so as to form a chemical vapor deposition diamond layer.

In conclusion, the method for manufacturing the cutter wheel in the present invention is performed with surface-modification on the surface of the substrates such that the attachment intensity between the substrates and the cutting unit can be enhanced, and then is completed with soldering to complete cutter wheel structure of the present invention. Therefore, the present invention can dramatically enhance the chemical attachment between the cutting unit and the substrates and the mechanical strength of the cutter wheel. Besides, the time and the costs for manufacturing the cutter wheel can also be efficiently reduced.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of the cutter wheel in Example 1 of the present invention;

FIGS. 2a to 2f show a flowchart for manufacturing the cutter wheel shown in FIG. 1;

FIGS. 3a and 3b show a perspective view of the axle holes of the cutter wheel in the present invention; and

FIG. 4 is an exploded view of the cutter wheel in Example 2 of the present invention.

### DETAILED DESCRIPTION OF THE PREFERRED EMBODIMENT

### EXAMPLE 1

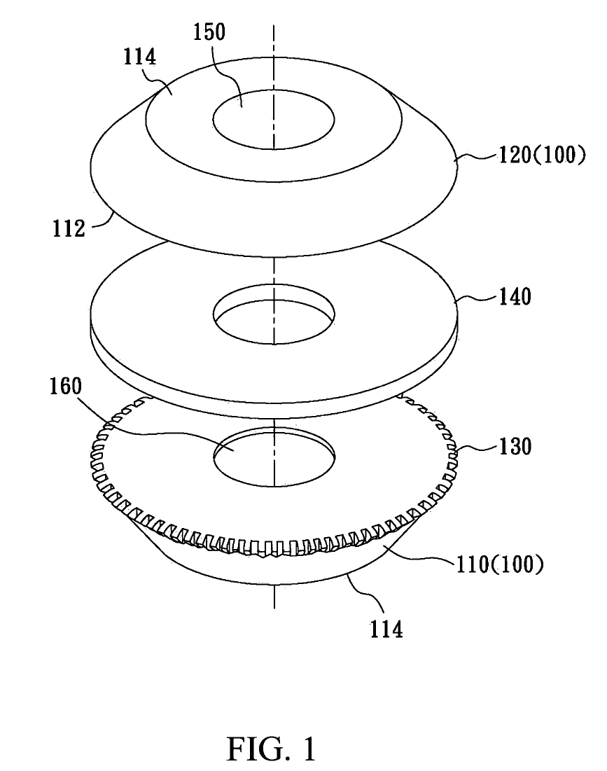

FIG. 1, shows an exploded view of a cutter wheel prepared in one example of the present invention. The cutter wheel can be applied in cutting glass. The cutter wheel includes a cutter wheel body 100 consisting of a first substrate 110 and a second substrate 120, wherein the substrates 110,120 each has an inner surface 112 and an outer surface 114, the outer diameter of the inner surface 112 is larger than that of the outer surface 114, and the cutter wheel body 100 has a plurality of a first axle holes 150; a solder layer 140 formed on the inner surface 112 of the second substrate 120; and a cutting unit 130 interposed between the first substrate 110 and the second substrate 120, wherein the cutting unit 130 has a second axle hole 160, and the first and second axle holes 150,160 respectively penetrate through the cutter wheel body 100 and the cutting unit 130, wherein the inner surface 112 of the first substrate 110 is surface-modified and the hardness of the cutting unit 130 is greater than that of the substrates 110,120.

In the present example, the inner surface 112 of the first substrate 110 is surface-modified by plasma treatment or acid corrosion, but preferably by plasma treatment under the atmosphere of oxygen or nitrogen. In other preferred examples, surface modification also can be achieved by nitric acid or sulfuric acid corrosion. Besides, in the cutter wheel of the present example, the solder layer mainly comprises silver/copper/tin/titanium powders, or nickel/chromium alloy powders. In detail, the inner surface 112 of the first substrate 110 is modified and roughened to promote the attachment intensity between the first substrate 110 and the cutting unit 130. Furthermore, according to the cutter wheel of the present invention, the material of one of the substrates 110,120 comprises metal, metal carbide, metal alloy, metal nitride, or metal oxide, but preferably is carbon, nitrogen, oxygen, aluminum, boron, silicon, wolfram, the metal alloy thereof, or the compound thereof. In the present invention, the material of the substrates 110,120 is wolfram carbide, and the thickness thereof is 0.1 mm to 10 mm. The cutting unit 130 comprises a chemical vapor deposition diamond layer, and the thickness thereof is 5 μm to 1 mm. In order to increase the cutting efficiency, the cutting unit 130 can have a cutter edge which is processed into smooth arcs or irregular serrations.

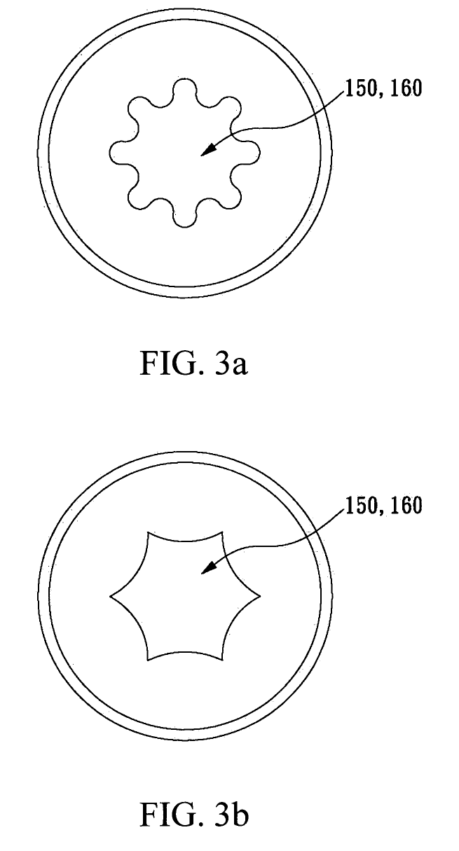

Moreover, according to the cutter wheel of the present invention, the first and second axle holes 150,160 can further have a plurality of concavo-convex portions continuously disposed therein (FIGS. 3a and 3b). The first and second axle holes 150,160 are disposed in the centers or off the centers of the cutter wheel body 100 and the cutting unit 130. Additionally, the first and second axle holes 150,160 are a closed smooth curve (not shown in the figures). Hence, during cutting, the jittering frequency of the cutter wheel can be increased to promote the cutting efficiency thereof.

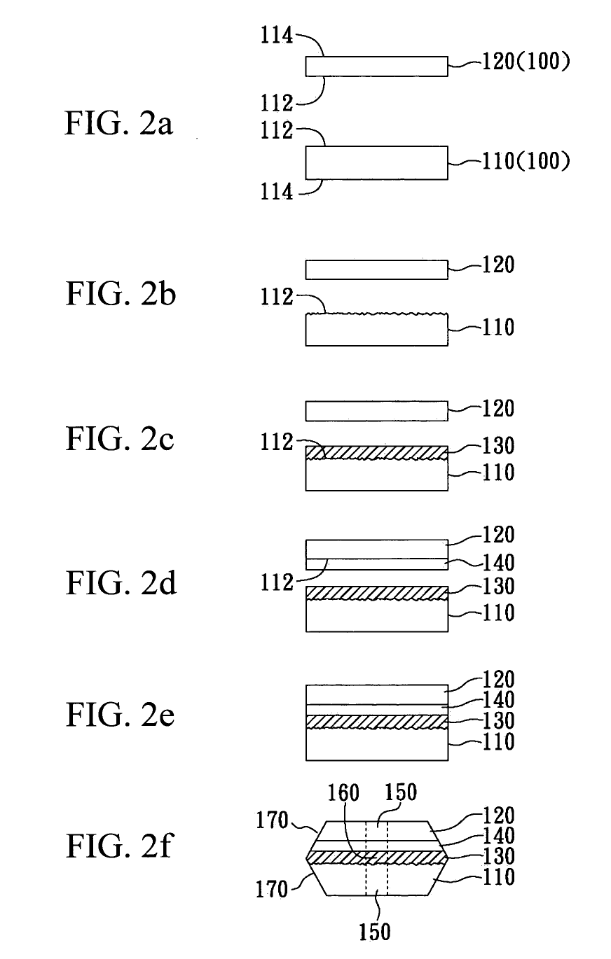

In the present example, a method for manufacturing the cutter wheel for cutting glass is illustrated as follows. With reference to FIG. 2a, a cutter wheel body 100 is provided first, and it consists of a first substrate 110 and a second substrate 120. The substrates 110,120 are made of wolfram carbide and each has an inner surface 112 and an outer surface 114. As shown in FIG. 2b, the inner surface 112 of the first substrate 110 is surface-modified, for example, by plasma treatment under the atmosphere of hydrogen so that it is roughened and carbon is removed. In FIG. 2c, a cutting unit 130 is formed on the surface-modified inner surface 112, and it is a chemical vapor deposition diamond layer. With reference to FIG. 2d, a solder layer 140 is formed on the inner surface 112 of the second substrate 120 by vacuum deposition, electroplating, or coating. Besides, the first and second substrates 110,120 are connected by soldering at a high temperature to form a structure as shown in FIG. 2e. Finally, in FIG. 2f, a plurality of the first axle holes 150 and a second axle hole 160 are formed respectively in the cutter wheel body 100 and the cutting unit 130, and they penetrate therethrough, respectively. Meantime, a cutter edge 170 can be formed on the periphery of the cutting unit 130 by mechanical polishing or electrical discharge wire cutting to make the outer diameter of the inner surface 112 of the substrate 110,120 larger than that of the outer surface 114 thereof. The cutter edge 170 can show a smooth or unsmooth curve.

According to the method for manufacturing the cutter wheel in the present invention, the inner surface 112 of the first substrate 110 is surface-modified to enhance the attachment intensity between the first substrate 110 and the cutting unit 130 formed by the chemical vapor deposition. Then, the cutter wheel structure of the present invention is completed by the solder layer 140 formed on the inner surface 112 of the second substrate 120, i.e. by plating and soldering. Hence, the present invention can dramatically enhance the chemical attachment between the cutting unit and the substrates and the mechanical strength of the cutter wheel. Besides, the deflection of the cutting unit, the time and the costs for manufacturing the cutter wheel can also be efficiently reduced.

### EXAMPLE 2

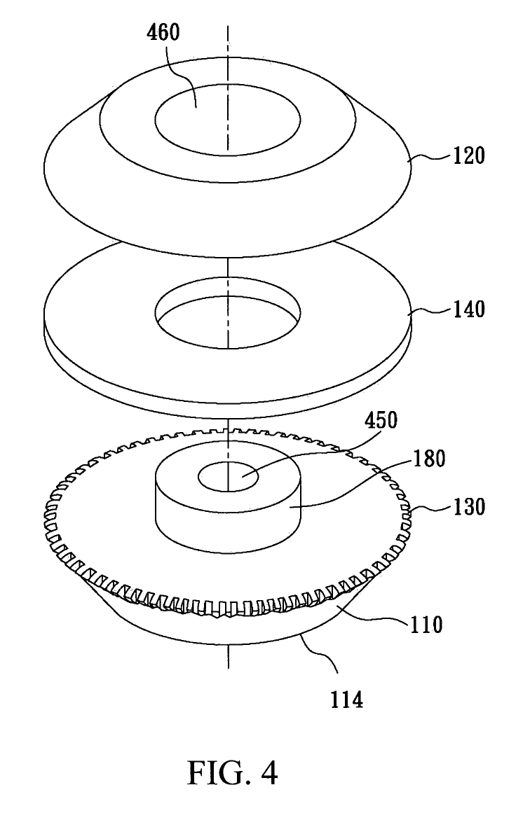

FIG. 4 shows an exploded view of the cutter wheel in another example of the present invention. In the present example, the cutter wheel structure is manufactured in a similar manner of Example 1 except the inner surface 112 of the first substrate 110 further comprises a flange structure 180. The flange structure 180 and the first substrate 110 have a first axle hole 450 penetrating therethrough. The second substrate 120 opposite to the first substrate 110 has a second axle hole 460, and the inner diameter of the second axle hole 460 is the same as the outer diameter of the flange structure 180. Therefore, the design of the flange structure 180 can prevent the roller and the cutting unit from prematurely wearing over long term use.

Although the present invention has been explained in relation to its preferred embodiment, it is to be understood that many other possible modifications and variations can be made without departing from the scope of the invention as hereinafter claimed.

What is claimed is:

1. A cutter wheel comprising:
a cutter wheel body, consisting of a first substrate and a second substrate, wherein the first and second substrates each has an inner surface and an outer surface, and the inner surface of the first substrate has a rough portion formed thereon;
a cutting unit formed on the rough portion; and
a solder layer formed between the cutting unit and the second substrate.

2. The cutter wheel as claimed in claim 1, wherein the cutter wheel body has a plurality of the first axle holes, the cutting unit has a second axle hole, and the first and second axle holes penetrate through the cutter wheel body and the cutting unit, respectively.

3. The cutter wheel as claimed in claim 1, wherein the first and second substrates comprise metal, metal carbide, metal alloy, metal nitride, or metal oxide.

4. The cutter wheel as claimed in claim 3, wherein the first and second substrates comprise carbon, nitrogen, oxygen, aluminum, boron, silicon, wolfram, the metal alloy thereof, or the compound thereof.

5. The cutter wheel as claimed in claim 2, wherein the first and second axle holes are disposed in the centers or off the centers of the cutter wheel body and the cutting unit.

6. The cutter wheel as claimed in claim 1, wherein the cutting unit is a chemical vapor deposition diamond layer.

7. The cutter wheel as claimed in claim 1, wherein the cutting unit has a cutter edge which is smooth arcs or irregular serrations.

8. The cutter wheel as claimed in claim 1, wherein one of the first and second substrates further comprises a flange structure.

9. The cutter wheel as claimed in claim 8, wherein the flange structure has an axle hole disposed in the center thereof, and is sleeved onto the surfaces of the first and second substrates.

10. The cutter wheel as claimed in claim 1, wherein the solder layer comprises silver/copper/tin/titanium powders, or nickel/chromium alloy powders.

11. A method for manufacturing a cutter wheel, comprising the following steps:
providing a cutter wheel body, consisting of a first substrate and a second substrate, wherein the first and second substrates each has an inner surface and an outer surface;
surface-modifying the inner surface of the first substrate to form a rough portion thereon;
forming a cutting unit on the rough portion;
forming a solder layer on the inner surface of the second substrate; and
aligning and connecting the first and second substrates by the solder layer.

12. The method as claimed in claim 11, wherein the inner surface of the first substrate is surface-modified by plasma treatment or acid corrosion.

13. The method as claimed in claim 12, wherein the inner surface of the first substrate is surface-modified by plasma treatment under the atmosphere of oxygen or hydrogen.

14. The method as claimed in claim 11, wherein a cutter edge is formed on the periphery of the cutting unit, and the cutter edge is smooth arcs or irregular serrations.

15. The method as claimed in claim 14, wherein the method of forming the cutter edge comprises mechanical polishing or electrical discharge wire cutting.

16. The method as claimed in claim 11, wherein a plurality of the first axle holes and a second axle hole are formed respectively in the cutter wheel body and the cutting unit, and the first and second axle holes penetrate through the cutter wheel body and the cutting unit, respectively.

17. The method as claimed in claim 16, wherein the first and second axle holes are disposed in the centers or off the centers of the cutter wheel body and the cutting unit.

18. The method as claimed in claim 16, wherein the method of forming the first and second axle holes comprises electrical discharge wire cutting or machining.

19. The method as claimed in claim 11, wherein the method of forming the cutting unit comprises chemical vapor deposition.

20. The method as claimed in claim 11, wherein the method of forming the solder layer comprises vacuum deposition, electroplating, or coating.
